(19) United States
(12) Patent Application Publication
(10) Pub. No.: US 2012/0194123 A1
(43) Pub. Date: Aug. 2, 2012

(54) FAN ROTATION SPEED CONTROL CIRCUIT

(75) Inventors: Yu-Liang Lin, Pingtung County (TW); Chun-Hsueh Lee, Pingtung County (TW)

(73) Assignee: ADDA CORP., Pingtung County (TW)

(21) Appl. No.: 13/332,572

(22) Filed: Dec. 21, 2011

(30) Foreign Application Priority Data
Jan. 28, 2011 (TW) 100201927

(51) Int. Cl. H02P 23/08

(52) U.S. Cl. 318/812

(57) ABSTRACT

A fan rotation speed control circuit comprises an AC power source, a coil electrically connected with the AC power source, a sensing module having a first resistor and a sensing device in parallel connection with mentioned first resistor, a capacitor, a DIAC, and a TRIAC having a first terminal, a second terminal and a gate terminal, wherein mentioned coil electrically connected with the first resistor and the sensing device, mentioned capacitor electrically connected with the first resistor and the sensing device, mentioned DIAC electrically connected with the first resistor, the sensing device and the capacitor, mentioned first terminal electrically connected with the first resistor, the sensing device and the coil, mentioned second terminal electrically connected with the capacitor and the AC power source, and mentioned gate terminal electrically connected with the DIAC.

### FIELD OF THE INVENTION

The present invention is generally relating to a fan rotation speed control circuit, which particularly illustrates the fan rotation speed control circuit being adaptive to adjust fan rotation speed corresponded to different environmental variation.

### BACKGROUND OF THE INVENTION

A conventional fan rotation speed control circuit 200 as shown in FIG. 1 comprises an AC power source 210, a coil 220, a resistor 230, a variable resistor 240, a capacitor 250, a DIAC 260 and a TRIAC 270, wherein the coil 220 is electrically connected with the AC power source 210, mentioned coil 220 is electrically connected with the resistor 230 and one end of the TRIAC 270, and another end of the resistor 230 is electrically connected with the variable resistor 240. The capacitor 250 is electrically connected with the variable resistor 240. The resistor 230, the variable resistor 240 and the capacitor 250 are series connected in sequence. One end of the DIAC 260 is electrically connected with the variable resistor 240 and the capacitor 250. Another end of the DIAC 260 is electrically connected with a gate terminal 271 of the TRIAC 270. The fan rotation speed control circuit 200 may change the rotation speed of a fan via adjusting the resistance of the variable resistor 240. However, the rotation speed of the fan is limited to achieve the maximum rotation speed via restriction of the resistor 230 as illustrated in FIG. 2.

### SUMMARY

The primary object of the present invention is to provide a fan rotation speed control circuit comprising an AC power source, a coil, a sensing module, a capacitor, a DIAC and a TRIAC, wherein mentioned coil is electrically connected with the AC power source, and mentioned sensing module is electrically connected with the coil. Mentioned sensing module has a first resistor and a sensing device in parallel connection with the first resistor. The capacitor is electrically connected with the sensing module and in series connection with the sensing module. The DIAC is electrically connected with the sensing module and the capacitor. The TRIAC has a first terminal, a second terminal and a gate terminal, wherein mentioned first terminal is electrically connected with the sensing module and the coil, mentioned second terminal is electrically connected with the capacitor and the AC power source, and mentioned gate terminal is electrically connected with the DIAC. The sensing device may detect the environmental variation (such as temperature environmental variation or light variation) and adjust the fan rotation speed in correspond with different environmental variation. Besides, the fan rotation speed control circuit makes the fan possess capability to achieve maximum rotation speed.

### DESCRIPTION OF THE DRAWINGS

FIG. 1 is a circuit diagram illustrating a conventional fan rotation speed control circuit.

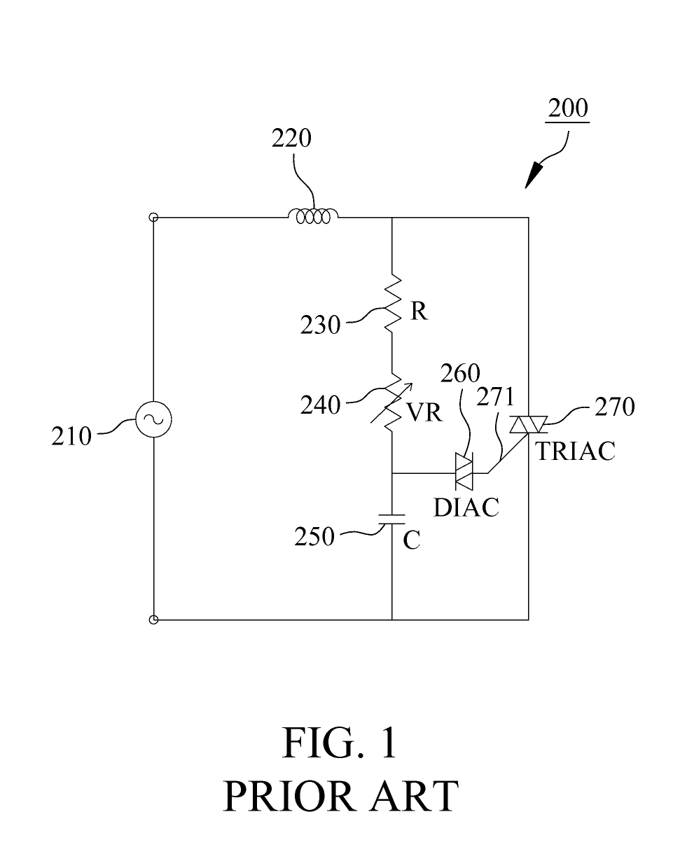

FIG. 2 is a fan rotation speed curve of the conventional fan rotation speed control circuit.

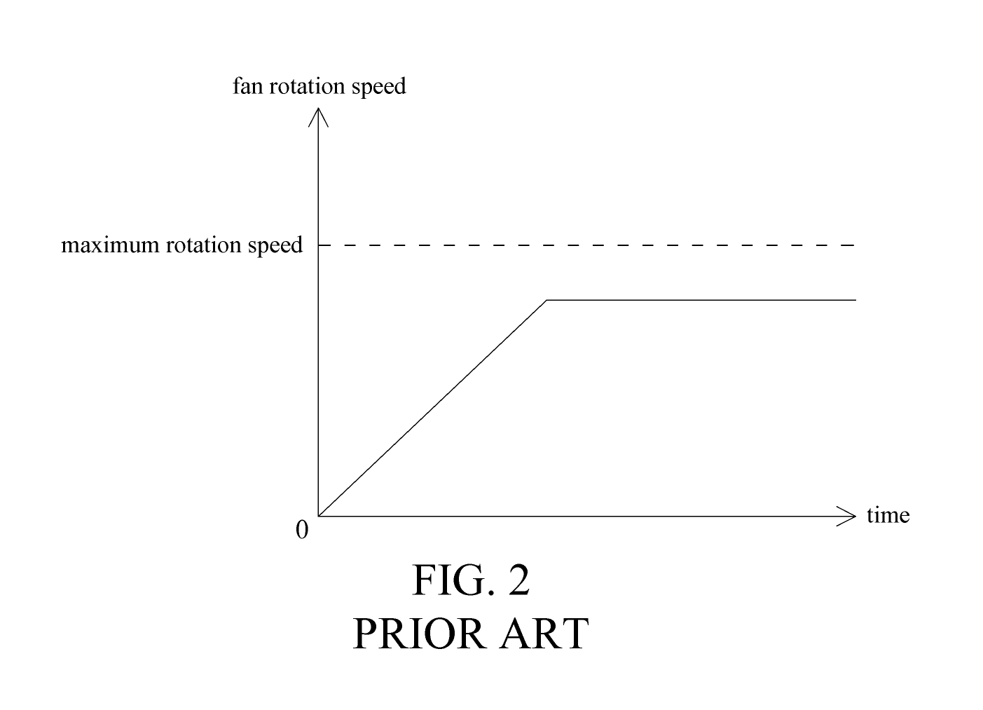

FIG. 3 is a circuit diagram illustrating a fan rotation speed control circuit in accordance with a first preferred embodiment of the present invention.

FIG. 4 is a fan rotation speed curve illustrating the fan rotation speed control circuit in accordance with the first preferred embodiment of the present invention.

FIG. 5 is a circuit diagram illustrating the fan rotation speed control circuit in accordance with a second preferred embodiment of the present invention.

FIG. 6 is a fan rotation speed curve illustrating the fan rotation speed control circuit in accordance with the second preferred embodiment of the present invention.

### DETAILED DESCRIPTION OF THE INVENTION

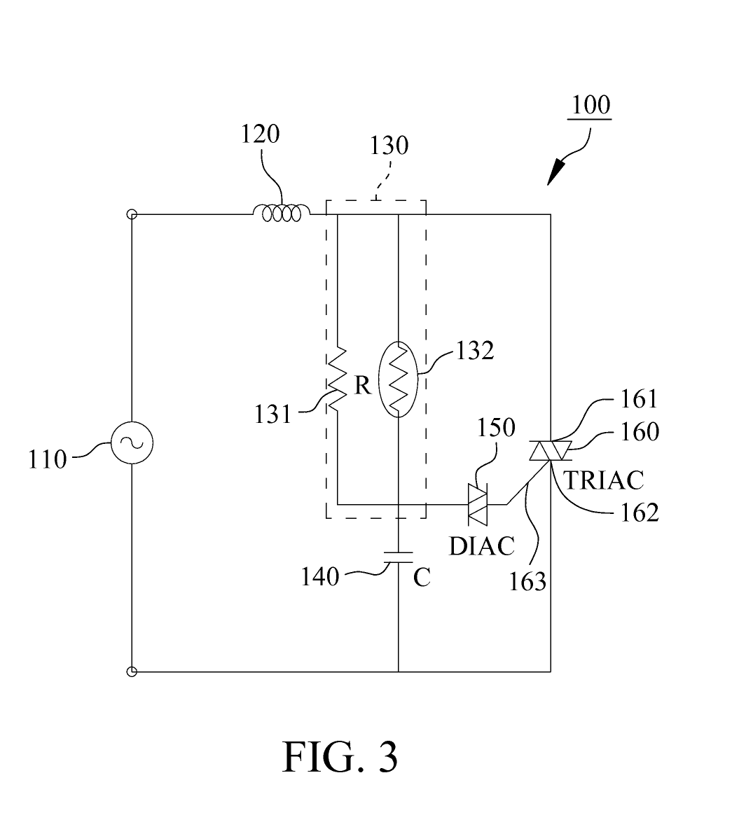

With reference to FIG. 3, a fan rotation speed control circuit 100 in accordance with a first preferred embodiment of the present invention comprises an AC power source 110, a coil 120, a sensing module 130, a capacitor 140, a DIAC (Diode for Alternating Current) 150 and a TRIAC (Triode for Alternating Current) 160, wherein mentioned coil 120 is electrically connected with the AC power source 110, and mentioned sensing module 130 is electrically connected with the coil 120. Mentioned sensing module 130 has a first resistor 131 and a sensing device 132 in parallel connection with the first resistor 131 and is utilized for sensation of environmental variation (environmental temperature variation or light variation) where a fan (not shown in Figure) is situated. In this embodiment, the sensing device 132 can be a temperature sensing device which is chosen from one of positive temperature coefficient thermistor or negative temperature coefficient thermistor, or, the sensing device 132 can be a light sensing device. The capacitor 140 is electrically connected with the sensing module 130, and the DIAC 150 is electrically connected with the sensing module 130 and the capacitor 140. The TRIAC 160 has a first terminal 161, a second terminal 162 and a gate terminal 163, wherein mentioned first terminal 161 is electrically connected with the sensing module 130 and the coil 120, mentioned second terminal 162 is electrically connected with the capacitor 140 and the AC power source 110, and mentioned gate terminal 163 is electrically connected with the DIAC 150.

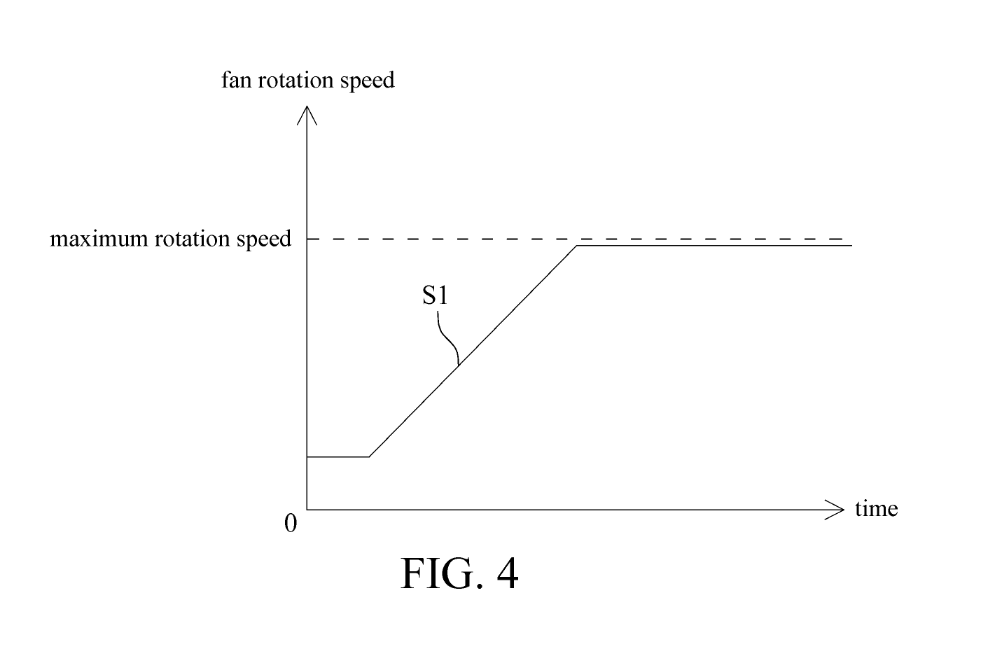

With reference to FIG. 3 again, the AC power source 110 may provide with an AC current passing through the coil 120, the first resistor 131 and the sensing device 132 and then actuates mentioned capacitor 140 to start charging. When the cross-voltage of the capacitor 140 rises to a predetermined value, the DIAC 150 is in conduction and enables the cross voltage of the capacitor 140 to trigger the gate terminal 163 of the TRIAC 160 to start discharge. Thereafter, the TRAIC 160 switched back to its non-conduction state as long as discharge finished. Via charge/discharge procedure of the capacitor 140 in the fan rotation speed control circuit 100, phase angle of the TRIAC 160 triggered by the DIAC 150 is controllable such that the fan may generate a certain rotation speed corresponded to a certain phase angle. When the fan rotation speed control circuit 100 is situated in a changeable environment (temperature environmental variation or light variation), the sensing device 132 may detect the external environmental variation and produce a resistance variation. For the reason that the sensing device 132 is in parallel connection with the first resistor 131, the equivalent resistance of the sensing module 130 is variable. Therefore, the phase angle of the TRIAC 160 triggered by the DIAC 150 will be changed via previously mentioned variation such that the slope of rotating speed for the fan is adjustable. In this embodiment, a first slope S1 is formed while the rotation speed of the fan going up as illustrated in FIG. 4 which indicates a fan rotation speed curve.

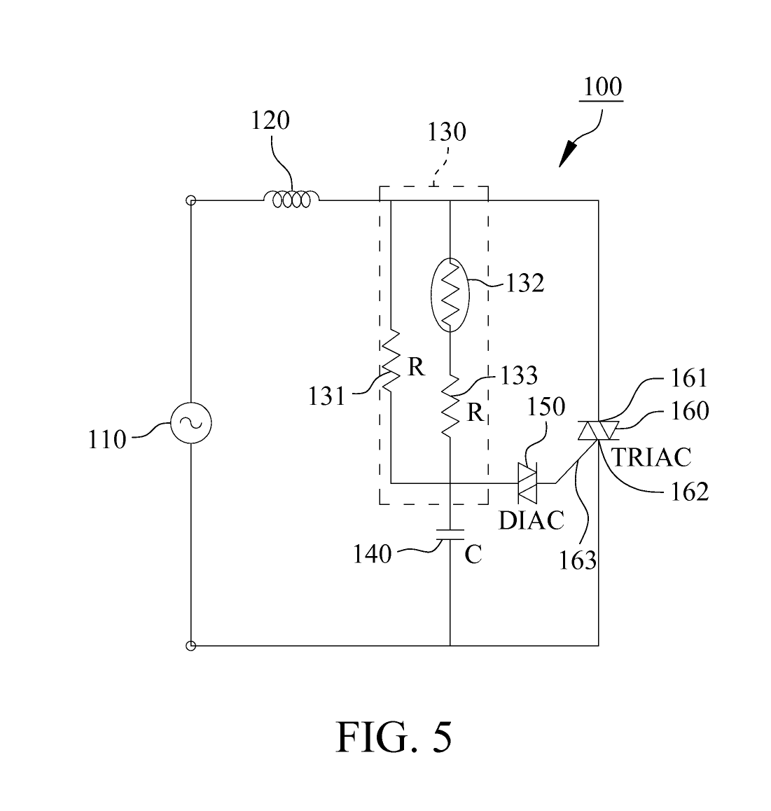

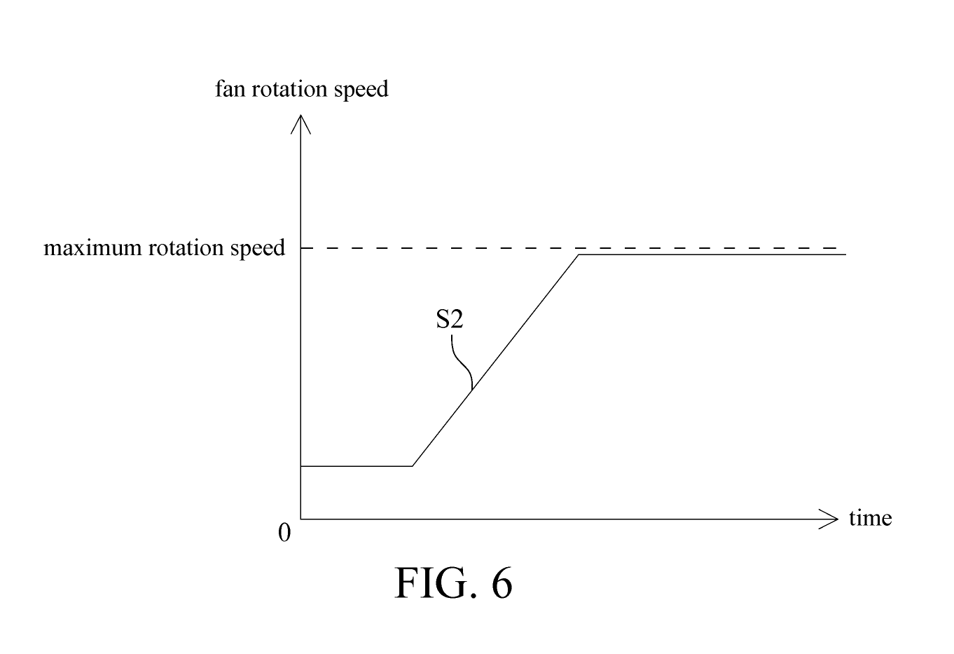

Referring to FIG. 5, which illustrates a second preferred embodiment of the present invention, the primary difference between the second embodiment and the first embodiment is that the sensing module 130 further comprises a second resistor 133, and mentioned second resistor 133 is electrically connected with the sensing device 132 and the capacitor 140 separately. FIG. 6 illustrates a fan rotation speed curve corresponded to the second embodiment. For the resistance variation caused by series connection of the second resistor 133 and the sensing device 132, a second slope S2 is formed while the rotation speed of the fan going up as shown in FIG. 6. Owing to the circuit design of the second embodiment is different from that of the first embodiment, the second slope S2 will be different as compared with the first slope S1.

In this invention, the sensing device 132 may detect the environmental variation and produce a resistance variation which leads the equivalent resistance of the sensing module 130 become variable. Therefore, the phase angle of the TRIAC 160 triggered by the DIAC 150 will be changed via previously mentioned variation such that the slope variation of rotating speed for the fan is adjustable. In addition, the design of the fan rotation speed control circuit 100 makes the fan possess capability to achieve maximum rotation speed.

While this invention has been particularly illustrated and described in detail with respect to the preferred embodiments thereof, it will be clearly understood by those skilled in the art that it is not limited to the specific features and describes and various modifications and changes in form and details may be made without departing from the spirit and scope of this invention.

What is claimed is:

1. A fan rotation speed control circuit comprising:
an AC power source;
a coil electrically connected with the AC power source;
a sensing module having a first resistor and a sensing device in parallel with mentioned first resistor, wherein mentioned coil electrically connected with the first resistor and the sensing device;
a capacitor electrically connected with the first resistor and the sensing device;
a DIAC electrically connected with the first resistor, the sensing device and the capacitor; and
a TRIAC having a first terminal, a second terminal and a gate terminal, wherein mentioned first terminal electrically connected with the first resistor, the sensing device and the coil, mentioned second terminal electrically connected with the capacitor and the AC power source, and mentioned gate terminal electrically connected with the DIAC.

2. The fan rotation speed control circuit in accordance with claim 1, wherein the sensing device can be a temperature sensing device which is chosen from one of positive temperature coefficient thermistor or negative temperature coefficient thermistor.

3. The fan rotation speed control circuit in accordance with claim 1, wherein the sensing device can be a light sensing device.

4. The fan rotation speed control circuit in accordance with claim 1, wherein the sensing module further comprises a second resistor electrically connected with the sensing device and the capacitor.
